(19) United States
(12) Patent Application Publication
(10) Pub. No.: US 2011/0187792 A1
(43) Pub. Date: Aug. 4, 2011

(54) PRINTER-PLOTTER APPARATUS

(75) Inventors: Akira Ikeda, Nagano (JP); Masaru Ohnishi, Nagano (JP)

(73) Assignee: MIMAKI ENGINEERING CO., LTD., Nagano (JP)

(21) Appl. No.: 12/740,583

(22) PCT Filed: Sep. 25, 2009
(86) PCT No.: PCT/JP2009/066636

§ 371 Date: Jun. 17, 2010

(30) Foreign Application Priority Data
Sep. 25, 2008 (JP) 2008-246543

(51) Int. Cl. B41J 23/00

(52) U.S. Cl. 347/37

(57) ABSTRACT

To improve printing speed and cutting speed.

Slidably supported by a guide rail 40 are a normal color head unit 50 for ejecting normal color ink droplets, a cutter unit 60 for conducting a cutting process, and a special color head unit 70 for ejecting special color ink droplets. A first driving carriage 80 capable of moving in the lateral direction is disposed between the normal color head unit 50 and the cutter unit 60, and a second driving carriage 90 capable of moving in the lateral direction is disposed between the cutter unit 60 and the special color head unit 70. The normal color head unit 50, the cutter unit 60, and the special color head unit 70 are separately independently moved in the lateral direction along the guide rail 40 by controlling the movement of the first driving carriage 80 and the second driving carriage 90.

### TECHNICAL FIELD

The present invention relates to a printer-plotter apparatus for conducting a printing process on a medium by ejecting ink droplets onto the medium and for conducting a cutting process relative to the medium.

### BACKGROUND ART

Conventionally, there is known a printer-plotter apparatus (cutting plotter) comprising a head unit for printing on a medium by ejecting ink droplets onto the medium and a cutter unit for conducting a cutting process relative to the medium.

The head unit and the cutter unit of the printer-plotter apparatus are supported by a guide rail disposed above a platen such that the head unit and the cutter unit are movable. The cu ter unit is attached to a belt which is driven by driving force of an electric motor so that the cutter unit is moved along the guide rail by the driving of the belt. On the other hand, the head unit is detachably attached to the cutter unit so that, according to the movement of the cutter unit, the head unit is moved along the guide rail (see, for example, Patent document 1).
Patent document 1: JP-A-H09-058016

### Problems to be Solved by the Invention

Recently, for the purpose of improving image quality of printed images, many special color inks such as Lm (Light Magenta), Lc (Light Cyan) are prepared besides normal color (DIC standard color) inks such as Y (Yellow), M (Magenta), C (Cyan), and K (Black). However, normally the conventional printer-plotter apparatus ejects ink droplets from a head unit in which normal color inks and special color inks are set as one unit so that there is a problem that the head unit should be so large as to interfere with high-speed printing and high-speed cutting.

It is an object of the present invention to provide a printer-plotter apparatus capable of high-speed printing and high-speed cutting.

### Means for Solving the Problems

A printer-plotter apparatus according to the present invention is a printer-plotter apparatus for conducting a printing process on a medium put on a platen by ejecting ink droplets onto the medium and for conducting a cutting process relative to the medium. The printer-plotter apparatus comprises: a long guide rail disposed above the platen; a first head unit, a second head unit, and a third head unit movably held by the guide rail; a first driving means which is disposed between the first head unit and the second head unit and is detachably connected to at least one of the first head unit and the second head unit and which moves along the guide rail; and a second driving means which is disposed between the second head unit and the third head unit and is detachably connected to at least one of the second head unit and the third head unit and which moves along the guide rail.

According to the printer-plotter apparatus, the first head unit is connected to the first driving means, whereby the first head unit is moved along the guide rail. The second head unit is connected to the first driving means or the second driving means, whereby the second head unit is moved along the guide rail. The third head unit is connected to the second driving means, whereby the third head unit is moved along the guide rail. Then, there are the three head units which are independently moved along the guide rail. For example, the head units for ejecting ink droplets can be assigned as the head unit for normal color inks and the head unit for special color inks. Therefore, the weight and size of the single unit is reduced, thereby improving the moving speed of the head unit.

In this case, it is preferable that the first head unit is a head unit which ejects normal color ink droplets onto the medium; the second head unit is a cutter unit which conducts a cutting process relative to the medium; and the third head unit is a head unit which ejects special color ink droplets onto the medium.

Generally, a printing with special color inks is rarely conducted and a printing with normal color inks and a cutting process are frequently conducted. Therefore, among the three head units, the head unit located at an end side is assigned as the head unit for ejecting special color ink droplets, whereby normally, a printing with normal color inks or a cutting process can be conducted by setting the third head unit in the standby position and by moving only the first head unit or the second head unit. On the other hand, a printing with special color inks can be conducted by setting the second head unit and the third head unit and by moving only the first head unit. In this manner, the third head unit for less-frequently-used special color inks, which is separated from the first head unit for frequently-used normal color inks, is employed, thereby improving the printing speed and the cutting speed. In addition, since the head unit for ejecting special color inks is positioned at the end-side of the guide rail, it can efficiently switch between the printing with normal color inks/cutting process and the printing with special color inks.

### Effect of the Invention

According to the present invention, it is possible to improve the printing speed and the cutting speed.

### BRIEF DESCRIPTION OF THE DRAWINGS

FIG. 1 is a partial enlarged view of a printer-plotter apparatus according to an embodiment.

FIG. 2 is an illustration showing a structure of a first driving unit and a second driving unit.

FIG. 3 is a flow chart showing processing actions of the printer-plotter apparatus.

FIG. 4 is a flow chart showing processing actions for setting a standby position for the normal color printing/cutting in FIG. 3.

FIG. 5 is a flow chart showing processing actions for setting a standby position for the special color printing in FIG. 4.

FIG. 6 is an illustration showing a state in which the printer-plotter apparatus is set in the standby position for the normal color printing/cutting.

FIG. 7 is an illustration showing a state in which a printing with normal color inks is conducted.

FIG. 8 is an illustration showing a state n which a cutting process is conducted.

FIG. 9 is an illustration showing a state midway through the setting of the printer-plotter apparatus in a standby position for a special color printing/cutting.

FIG. 10 is an illustration showing a state midway through the setting of the printer-plotter apparatus in the standby position or the special color printing/cutting.

FIG. 11 is an illustration showing a state midway through the setting of the printer-plotter apparatus in the standby position for the special color printing/cutting.

FIG. 12 is an illustration showing a state in which the printer-plotter apparatus is set in the standby position for the special color printing/cutting.

FIG. 13 is an illustration showing a state in which a printing with special color ink is conducted.

FIG. 14 is an illustration showing a state in which the printing with special color ink is conducted.

Hereinafter, a preferable embodiment of a printer-plotter apparatus according to the present invention will be described in detail with reference to the attached drawings. It should be noted that the same or corresponding components in the drawings are marked with the same numerals.

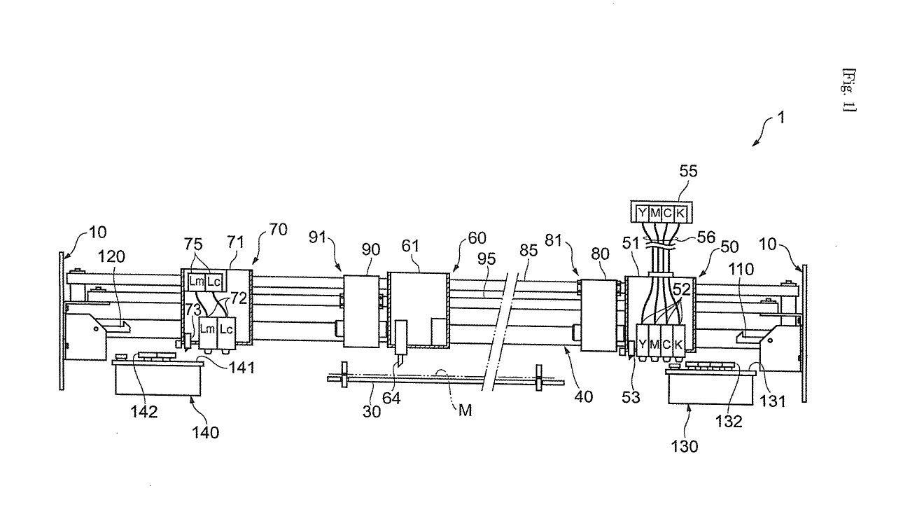

FIG. 1 is a partial enlarged view of a printer-plotter apparatus according to the embodiment. The printer-plotter apparatus 1 according to the embodiment has a function of printing an image on a medium M put on a platen 30 and also a function of conducting a cutting process relative to the medium M. As shown in FIG. 1, fixed to a body 10 of the printer-plotter apparatus 1 is a guide rail 40 extending along the extending direction of a platen 30 above the platen 30 which, supports the medium M.

Supported by the guide rail 40 are in the order from an end, a normal color head unit 50, a cutter unit 60, and a special color head unit 70 such that they are slidable. It should be noted that, in the following description, the direction of the platen 30 of moving closer or away relative to the guide rail 40 (the vertical direction in FIG. 1) is referred to as a vertical direction and the extending direction of the guide rail 40 (the lateral direction in FIG. 1) is referred to as a lateral direction.

The normal color head unit 50 is a head unit which conducts printing by ejecting ink droplets of normal colors, i.e. Y (Yellow), M (Magenta), C (Cyan), and K (Black) as DIC standard colors. The normal color head unit 50 comprises a carriage 51 movably attached to the guide rail 40, and four inkjet head modules 52 held by the carriage 51.

Mounted on the carriage 51 is a camera 53 for photographing the medium M fed to the platen 30. Based on images photographed by the camera 53, the width of the medium M fed to the platen 30 and the original position for the printing are detected. Though a mark (so-called tombo) printed on the medium M is defined as the original position for the printing in, this embodiment, the original position for the printing may be a mechanically defined position.

The inkjet head modules 52 which correspond to the colors Y, M, C, and K, respectively are aligned in the lateral direction on the side of the platen 30 of the carriage 51. On the lower surfaces of each inkjet head module 52, a plurality of nozzles which eject ink droplets of each color toward the platen 30 are provided. The normal color head unit 50 is connected to large-volume ink tanks 55 for storing the inks of the respective colors Y, M, C, and K via tubes 56. The normal color head unit 50 is timely replenished with inks of the respective colors from the ink tanks 55, whereby the normal color head unit 50 can eject ink droplets of the respective colors from the respective inkjet head modules 52.

The cutter unit 60 is a head unit for conducting a cutting process relative to the medium. The cutter unit 60 comprises the carriage 61 movably attached to the guide rail 40 and a cutter holder 62 attached to the carriage 61.

Mounted on the carriage 61 is a camera 63 for photographing the medium M fed to the platen 30. Based on the images photographed by the camera 63, the width of the medium M fed to the platen 30 and the original position for the printing are detected.

The cutter holder 62 holds a cutter member 64 which is mounted on the carriage 61 such that the cutter member 64 for cutting the medium M can move in the vertical direction. The cutter holder 62 holds the cutter member 64 such that the cutter member 64 is rotatable about a vertical axis as its rotation axis.

The special color head unit 70 is a head unit which conducts printing by ejecting ink droplets of special colors, i.e. Lm (Light Magenta) and Lc (Light Cyan). The special color head unit 70 comprises a carriage 71 movably attached to the guide rail 40, and two inkjet head modules 72 held by the carriage 71.

Mounted on the carriage 71 is a camera 73 for photographing the medium M fed to the platen 30. Based on images photographed by the camera 73, the width of the medium M fed to the platen 30 and the original position for the printing are detected.

The inkjet head modules 72 which correspond to the colors Lm and Lc, respectively are aligned in the lateral direction on the side of the platen 30 of the carriage 71. On the lower surfaces of each inkjet head module 72, a plurality of nozzles which eject ink droplets of each color toward the platen 30 are provided. It should be noted that the special color head unit 70 is used for increasing the variation of printable colors by superposing the special colors onto the normal colors ejected from the normal color head unit 50 and also used for printing contours along which the medium will be cut. Therefore, the frequency in use of the special color head unit 70 is lower than that of the normal color head unit 50. Ink cartridges 75 of small volume for supplying the inks of the respective colors Lm and Lc to the respective inkjet head modules 72 are detachably attached to the special color head unit 70. The inks of the respective colors are supplied from the ink cartridges 75 to the special color head unit 70, whereby the special color head unit 70 can eject ink droplets of the respective colors from the respective inkjet head modules 72.

Below one end side (the right end side in FIG. 1) of the guide rail 40 in the main body 10, a maintenance device 130 for maintenance of the normal color head unit 50 is disposed. Below the other end side (the left end side in FIG. 1) of the guide rail 40 in the main body 10, a maintenance device 140 for maintenance of the special color head unit 70 is disposed. The maintenance devices 130, 140 are composed of known maintenance devices. That is, the maintenance devices 130, 140 comprise stages 131, 141 which are movable in the vertical direction, and drying prevention members 132, 142 which are made of cloth or sponge having moisture-retaining property and are mounted on the stages 131, 141. By flushing the nozzles of the normal color head unit 50 and the special color head unit 70, the nozzles are prevented from being clogged. Accordingly, when the normal color head unit 50 is positioned at the right end of the guide rail 40 to face the maintenance device 130, the normal color head unit 50 is in its standby position. On the other hand, when the special color head unit 70 is positioned at the left end of the guide rail 40 to face the maintenance device 140, the special color head unit 70 is in its standby position.

At the standby position of the normal color head unit 50, the main body 10 is provided with a right hook mechanism 110 for engaging and fixing the normal color head unit 50. At the standby position of the special color head unit 70, the main body 10 is provided with a left hook mechanism 120 for engaging and fixing the special color head unit 70. The right hook mechanism 110 and the left hook mechanism 120 are driven, for example, by built-in solenoids so as to engage and disengage the normal color head unit 50 and the special color head unit 70.

In the printer-plotter apparatus 1, a first driving carriage 80 is disposed between the normal color head unit 50 and the cutter unit 60 and a second driving carriage 90 is disposed between the cutter unit 60 and the special color head unit 70. The first driving carriage 80 is attached to a first driving unit 81 which moves the normal color head unit 50 in the lateral direction along the guide rail 40. The second driving carriage 90 is attached to a second driving unit 91 which moves the cutter unit 60 and the special color head unit 70 in the lateral direction along the guide rail 40.

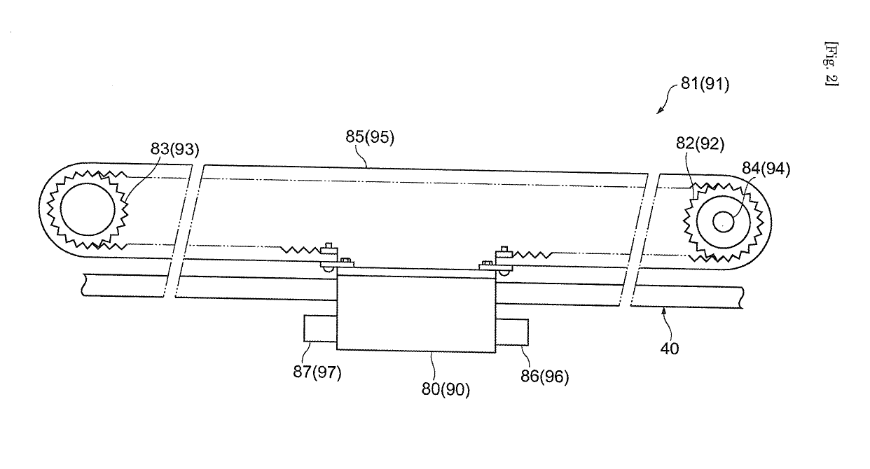

FIG. 2 is an illustration showing the structure of the first driving unit and the second driving unit. In FIG. 2, numerals shown in parentheses are numerals corresponding to the second driving unit 91. As shown in FIG. 2, the first driving unit 81 and the second driving unit 91 comprise driving pulleys 82, 92 and the driven pulleys 83, 93 positioned above the right and left ends of the guide rail 40, electric motors 84, 94 (for example, stepping motors and servo motors) for rotating the driving pulleys 82, 92, band-like driving belts 85, 95 wound around and extend between the driving pulleys 82, 92 and the driven pulleys 83, 93, and the first driving carriage 80 and the second driving carriage 90 which are supported by the guide rail 40 and connected to the driving belts 85, 95, respectively. The driving belts 85, 95 are toothed belts and the driving pulleys 82, 92 and the driven pulleys 83, 93 are provided with teeth, thereby preventing the belt slippage. The driving belts 85, 95 are not looped themselves and the first driving carriage 80 and the second driving carriage 90 are connected to the both ends of the driving belts 85, 95. Accordingly, the driving belts 85, 95 are looped through the first driving carriage 80 and the second driving carriage 90, respectively and are wound around and extend between the driving pulleys 82, 92 and the driven pulleys 83, 93 with some tension. The driving belts 85, 95 are arranged to extend between the driving pulleys 82, 92 and the driven pulleys 83, 93 above the guide rail 40 in the lateral direction parallel with the guide rail 40 such that the width direction thereof extends in the vertical direction. In the first driving unit 81 and the second driving unit 91 structured as mentioned above, the driving pulleys 82, 92 are rotated, by driving control of the electric motors 84, 94, thereby enabling the movement control of the driving belts 85, 95, the first driving carriage 80 and the second driving carriage 90 in the lateral direction.

The first driving carriage 80 comprises a normal color head unit connecting mechanism 86 which is detachably connected to the normal color head unit 50, and a cutter unit connecting mechanism 87 which is detachably connected to the cutter unit 60. The second driving carriage 90 comprises a cutter unit connecting mechanism 96 which is detachably connected to the cutter unit 60, and a special color head unit connecting mechanism 97 which is detachably connected to the special color head unit 70. For example, each connecting mechanism may be a connecting mechanism disclosed in Japanese Patent Application No. 2007.090534 which was previously filed by the present applicant.

By controlling the connections of the normal color head unit connecting mechanism 86, the cutter unit connecting mechanism 87, the cutter unit connecting mechanism 96, and the special color head unit connecting mechanism 97 and by controlling the actuation of the first driving unit 81 and the second driving unit 91, the normal color head unit 50, the cutter unit 60, and the special color head unit 70 can be moved along the guide rail 40 in the lateral direction separately and independently.

It should be noted that the printer-plotter apparatus 1 is provided with a controller (not shown) which comprises a CPU and a memory as its main components and which controls respective processing actions of the printer-plotter apparatus 1 mentioned above.

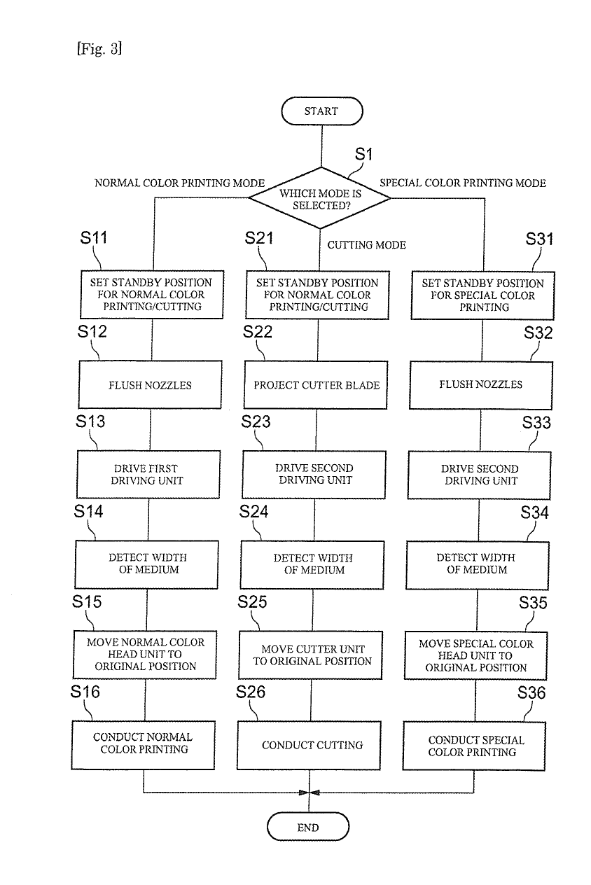

Description will now be made of actions of the printer-plotter apparatus 1 according to this embodiment with reference to FIG. 3 through FIG. 14.

FIG. 3 is a flow chart showing processing actions of the pr inter-plotter apparatus. As mentioned above, the printer-plotter apparatus 1 is used for conducting normal color printing, cutting, and special color printing. Therefore, as shown in FIG. 3, the printer-plotter apparatus 1 first determines which one of modes, i.e. the normal color printing mode, the cutting mode, and the spec al color printing mode will be started (step S1).

When it is determined that the normal color printing mode will be started in step S1, the printer-plotter apparatus 1 is set to be in the standby position for the normal color printing/cutting (step S11). That is, in the printer-plotter apparatus 1, the positions of the normal color head unit 50, the cutter unit 60, and the special color head unit 70 may be random in the guide rail 40, that is, not all of the units are returned to the standby positions when stopped at the last power-off. Therefore, at the start of the normal color printing mode, the normal color head unit 50, the cutter unit 60, and the special color head unit 70 are first moved to the default positions for starting the normal color printing mode.

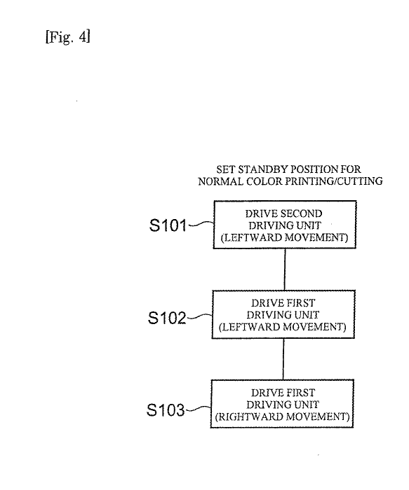

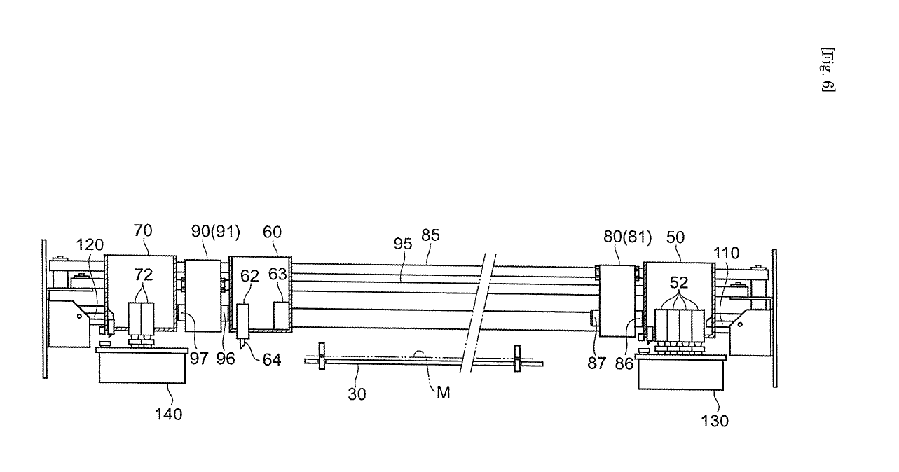

FIG. 4 is a flow chart showing processing action for setting the standby position for the normal color printing/cutting in FIG. 3 and FIG. 6 is an illustration showing a state that the printer-plotter apparatus is set in the standby position for the normal color printing/cutting. As shown in FIG. 4 and FIG. 6, for setting the standby position for the normal color printing/cutting, the second driving unit 91 is first driven to move the second driving carriage 90 to the left end of the guide rail 40 (step S101). Then, the second driving carriage 90 moves the special color head unit 70 to the left end along the guide rail 40 and pushes the special color head unit 70 against the left hook mechanism 120. Accordingly the special color head unit 70 is connected to the special head unit connecting mechanism 97 of the second driving carriage 90 and is engaged with the left hook mechanism 120 so that the spec al color head unit 70 is fixed at the standby position.

Then, the first driving unit 81 is driven to move the first driving carriage 80 to the left end of the guide rail 40 (step S102). Thus, the first driving carriage 80 moves the cutter unit 60 to the left end along the guide rail 40 and holds the cutter unit 60 between the special color head unit 70 fixed at the standby position and the first driving carriage 80. Accordingly, the cutter unit 60 is connected to the cutter unit connecting mechanism 87 of the first driving carriage 80 and the cutter unit connecting mechanism 96 of the second driving carriage 90 so that the cutter unit 60 is fixed at the left end portion of the guide rail 40.

Then, the connection between the cutter unit connecting mechanism 87 of the first driving carriage 80 and the cutter unit 60 is cancelled and the first driving unit 81 is driven to move the first driving carriage 80 to the right end of the guide rail 40 (step S103). Thus, the first driving carriage 80 moves the normal color head unit 50 to the right end along the guide rail 40 and pushes the normal color head unit 50 against the right hook mechanism 110. Accordingly, the normal color head unit 50 is connected to the normal color head unit connecting mechanism 86 of the first driving carriage 80 and is engaged with the right hook mechanism 110 so that the normal color head unit 50 is fixed at the standby position.

As the respective units are set in their standby positions for the normal color printing/cutting (see FIG. 6), the flushing operation is performed relative to the normal color head unit 50 (step S12). That is, since the normal color head unit 50 is fixed at the standby position in step S11, the flushing operation relative to the normal head unit 50 is performed by the maintenance device 130, thereby removing clogging of the respective nozzles.

Then, the engagement of the normal color head unit 50 by the right hook mechanism 110 is canceled and the first driving unit 81 is driven to move the first driving carriage 80 in the leftward direction (step S13). Accordingly, the first driving carriage 80 moves the normal head unit 50 in the leftward direction.

During this, the medium M fed to the platen 30 is photographed by the camera 53 mounted on the carriage 51 of the normal color head unit 50. Based on images photographed by the camera 53, ends of the medium M and a mark indicating the original position are detected, thereby detecting the width of the medium and the original position (step S14). Then, the first driving unit 81 is further driven to move the first driving carriage 80, thereby moving the normal color head unit 50 to the original position of the medium M (step S15).

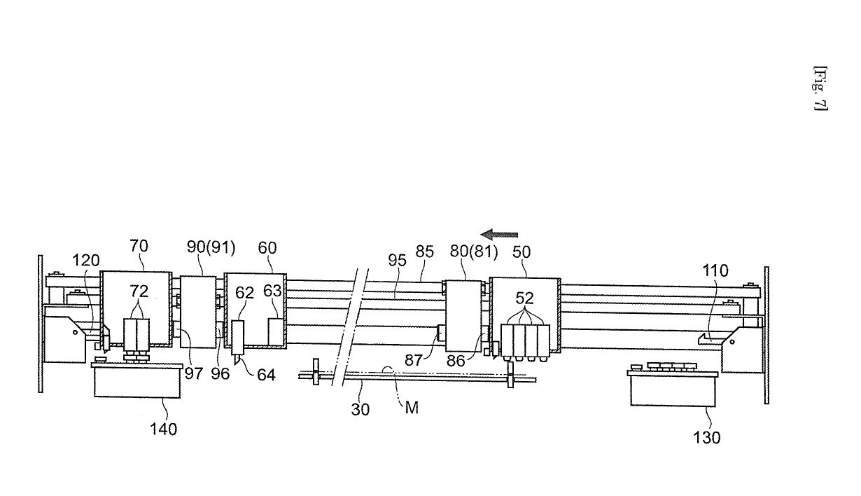

After the normal color head unit 50 is moved to the original position of the medium M, normal color printing on the medium M is conducted by controlling the driving of the first driving unit 81 and by controlling the ejection of the respective inkjet head modules 52 of the normal color head unit 50 (see FIG. 7) (step S16).

On the other hand, when it is determined that the cutting mode will be started in step S1 mentioned above, the printer-plotter apparatus 1 is set to be in the standby position for the normal color printing/cutting similarly to the case for the normal color printing mode (step S21). Since the standby position setting for the normal color p in step S21 is the same as the standby position setting for the normal color printing/cutting in step S11 (see FIG. 6), description about the standby position setting for this case will be omitted.

As all of the units are set in their standby positions for the normal color printing/cutting (see FIG. 6), the cutter member 64 is projected downwardly from the cutter holder 62 mounted on the carriage 61 of the cutter unit 60 (step S22).

Then, the connection between the special color head unit connecting mechanism 97 of the second driving carriage 90 and the special color head unit 70 is cancelled and the second driving unit 91 is driven to move the second driving carriage 90 in the rightward direction (step S23). Accordingly, the second driving carriage 90 moves the cutter unit 60 in the rightward direction.

During this, the medium M fed to the platen 30 is photographed by the camera 63 mounted on the carriage 61 of the cutter unit 60. Based on images photographed by the camera 63, ends of the medium M and a mark indicating the original position are detected, thereby detecting the width of the medium and the original position (step S24). Then, the second driving unit 91 is further driven to move the second driving carriage 90, thereby moving the cutter unit 60 to the original position of the medium M (step S25).

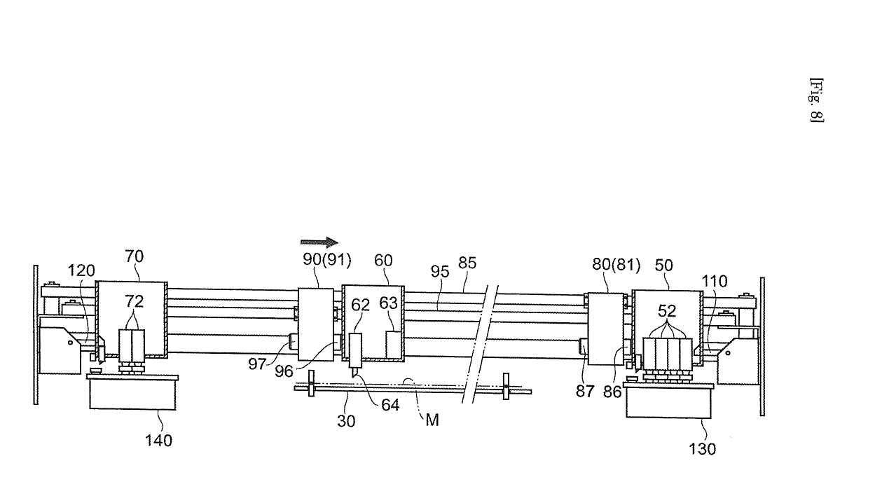

After the cutter unit 60 is moved to the original position of the medium M, cutting relative to the medium M is conducted, by controlling the driving of the second driving unit 91 and by controlling the vertical movement and rotation of the cutter member 64 (see FIG. 8) (step S26).

On the other hand, when it is determined that the special color printing mode will be started in step S1 mentioned above, the printer-plotter apparatus 1 is set to be in the standby position for the special color printing (step S31). That is, as mentioned above, in the printer-plotter apparatus 1, the positions of the normal color head unit 50, the cutter unit 60, and the special color head unit 70 may be random in the guide rail 40, that is, not all of the units are returned to the standby positions when stopped at the last power-off. Therefore, at the start of the special color printing mode, the normal color head unit 50, the cutter unit 60, and the spec default positions for starting the special color printing mode.

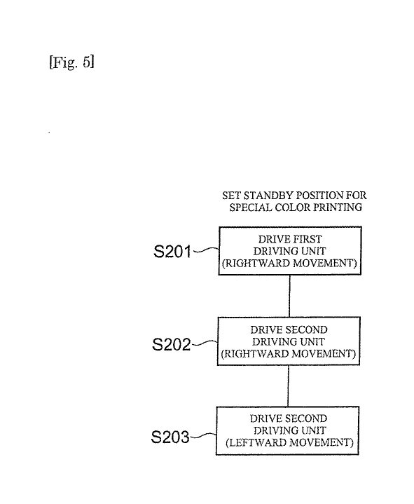

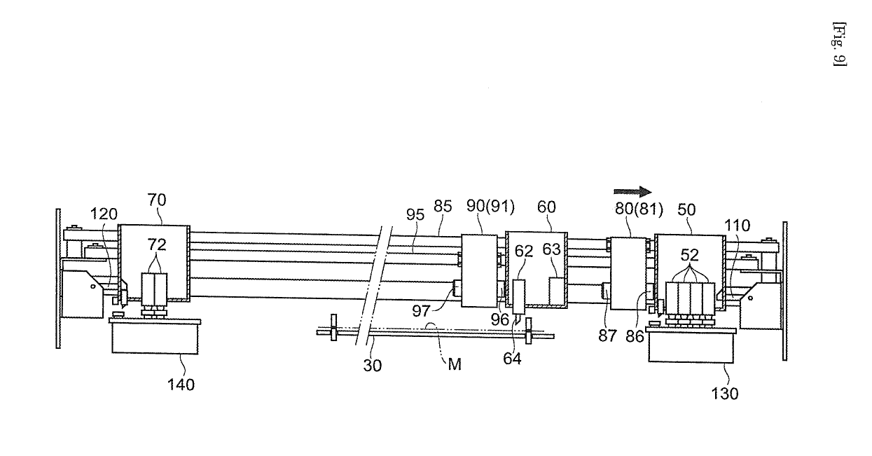

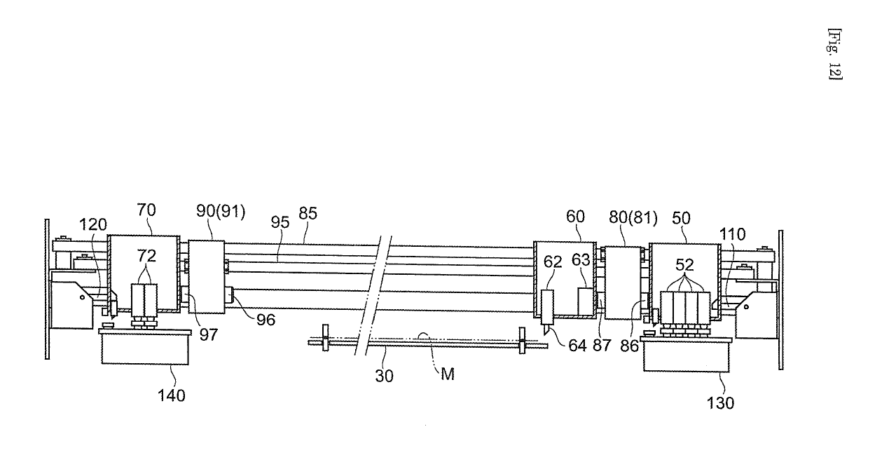

FIG. 5 is a flow chart showing processing action for setting the standby position for the special color printing in FIG. 3, FIG. 9 through FIG. 11 are illustrations showing states midway through the setting of the printer-plotter apparatus in the standby position for the special color printing, and FIG. 12 is an illustration showing a state that the printer-plotter apparatus is set in the standby position for the special color printing. As shown in FIG. 5 and FIGS. 9-12, for setting the standby position for the special color printing, the first driving unit 81 is first driven to move the first driving carriage 80 to the right end of the guide rail 40 (step S201). Then, the first driving carriage 80 moves the normal color head unit 50 to the right end along the guide rail 40 and pushes the normal color head unit 50 against the right hook mechanism 110. Accordingly, the normal color head unit 50 is connected to the normal head unit connecting mechanism 86 of the first driving carriage 80 and is engaged with the right hook mechanism 110 so that the normal color head unit 50 is fixed at the standby position (see FIG. 9).

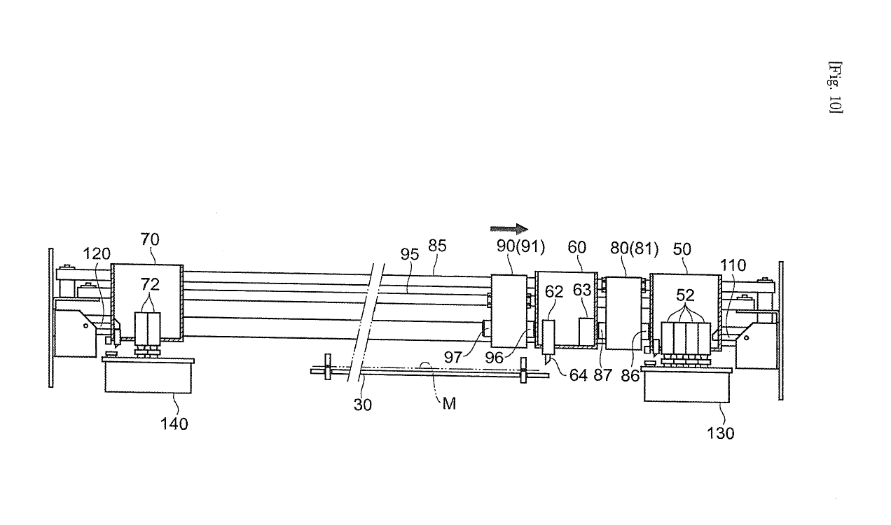

Then, the second driving unit 91 is driven to move the second driving carriage 90 in the rightward direction so that the second driving carriage 90 is moved to the right end of the guide rail 40 (step S202). Thus, the second driving carriage 90 moves the cutter unit 60 to the right end along the guide rail 40 and holds the cutter unit 60 between the normal color head unit 50 fixed at the standby position and the second driving carriage 90. Accordingly, the cutter unit 60 is connected to the cutter unit connecting mechanism 96 of the second driving carriage 90 and the cutter unit connecting mechanism 87 of the first driving carriage 80 so that the cutter unit 60 is fixed at the right end portion of the guide rail 40 (see FIG. 10).

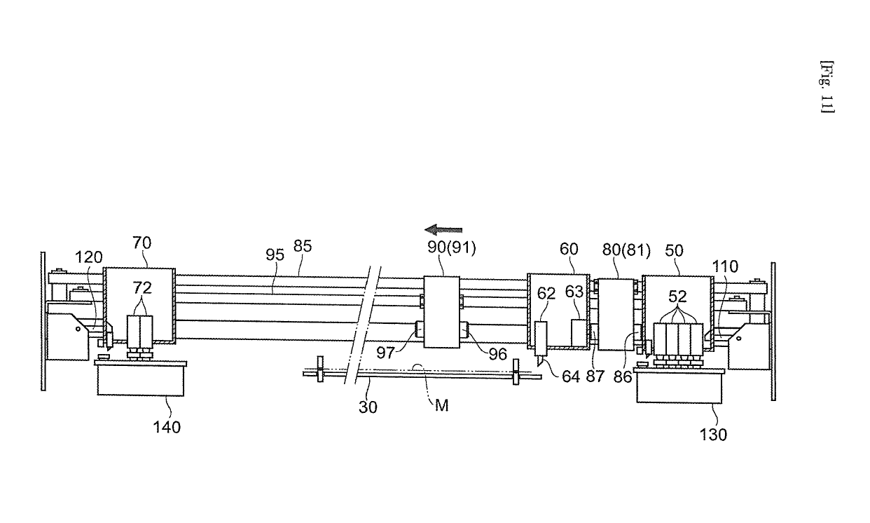

Then, the connection between the cutter unit connecting mechanism 96 of the second driving carriage 90 and the cutter unit 60 is cancelled and the second driving unit 91 is driven to move the second driving carriage 90 in the leftward direction so that the second driving carriage 90 is moved to the left end of the guide rail 40 (step S203). Thus, the second driving carriage 90 is moved alone to the left end along the guide rail 40 and pushes the special color head unit 70 against the left hook mechanism 120. Accordingly, the special color head unit 70 is connected to the special color head unit connecting mechanism 96 of the second driving carriage 90 and is engaged with the left hook mechanism 120 so that the special color head unit 70 is fixed at the standby position (see FIG. 11 and FIG. 12).

As the respective units are set in their standby positions for the special color printing (see FIG. 12), the flushing operation is performed relative to the special color head unit 70 (step S32). That is, since the special color head unit 70 is fixed at the standby position in step S31, the flushing operation relative to the special head unit 70 is performed by the maintenance device 140, thereby removing clogging of the nozzles.

Then, the engagement of the special color head unit 70 by the left hook mechanism 120 is canceled and the second driving unit 91 is driven to move the second driving carriage 90 in the rightward direction (step S33). Accordingly, the second driving carriage 90 moves the special head unit 70 in the rightward direction.

During this, the medium M fed to the platen 30 is photographed by the camera 73 mounted on the carriage 71 of the special color head unit 70. Based on mages photographed by the camera 73, ends of the medium M and a mark indicating the original position are detected, thereby detecting the width of the medium and the original position (step S34). Then, the second driving unit 91 is further driven to move the second driving carriage 90, thereby moving the special color head unit 70 to the original position of the medium M (step S35).

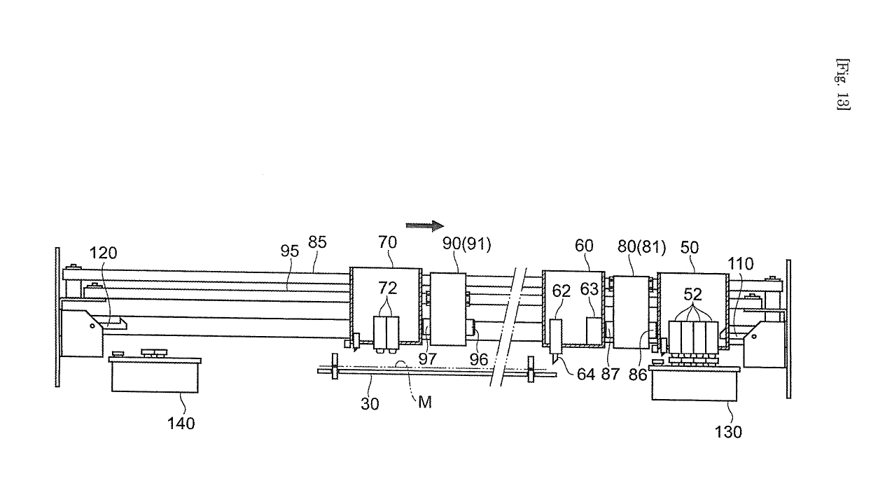

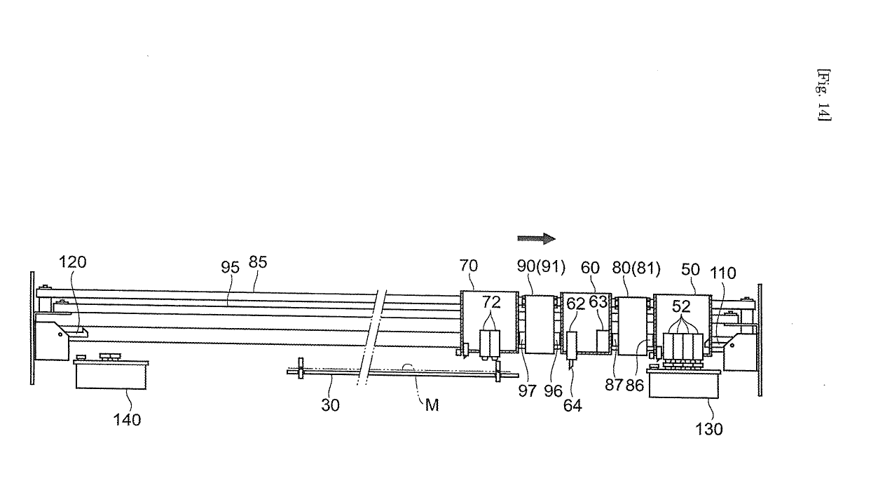

After the special color head unit 70 is moved to the original position of the medium M, special color printing on the medium M is conducted by controlling the driving of the second driving unit 91 and by controlling the ejection of the respective inkjet head modules 72 of the special color head unit 70 (see FIG. 13 and FIG. 14) (step S36).

In this manner, according to this embodiment, the normal color head unit 50 is moved along the guide rail 40 by connecting the normal color head unit 50 to the first driving carriage 80, the cutter unit 60 is moved along the guide rail 40 by connecting the cutter unit 60 to the first driving carriage 80 or the second driving carriage 90, and the special color head unit 70 is moved along the guide rail 40 by connecting the special color head unit 70 to the second driving carriage 90. Since the three head units capable of independently moving along the guide rail 40 are employed, each head unit can be structured to have reduced weight and reduced size, thereby improving the moving speed of the normal color head unit 50 and the special color head unit 70.

Since, among the three head units, the head unit located at the end side is assigned as the special color head unit 70, normally the special color head unit 70 is set in the standby position and only the normal color head unit 50 or the cutting unit 60 is moved, whereby a printing with normal color inks or a cutting process is allowed to be conducted. On the other hand, for conducting printing with special color inks, the normal color head unit 50 and the cutter unit 60 are set in their standby positions and only the special color head unit 70 is moved, thereby conducting the printing with special color inks. In this manner, the head unit for less-frequently-used special color inks, which is separated from the head unit for frequently-used normal color inks, is employed, thereby improving the printing speed and the cutting speed. In addition, since the special color head unit 70 is positioned at the end-side of the guide rail 40, it can efficiently switch between the printing with normal color inks/cutting process and the printing with special color inks.

Also according to this embodiment, the special color had unit 70 is designed to eject only less-frequently-used special color inks, thereby reducing the total amount of the special color inks used in the special color head unit 70. Therefore, as for the special color inks supplied to the special color head unit 70, the small-volume ink cartridges 75 are enough so that it is not necessary to separately provide large-volume ink tanks for the special color head unit 70, unlike the normal color head unit 50, thereby achieving reduction in size of the printer-plotter apparatus 1.

Though the present invention has been described with regard to the aforementioned preferred embodiment, the present invention is not limited to the aforementioned embodiment. For example, though the normal color inks to be ejected from the normal color head unit 50 are the four color inks Y, M, C, and K and the special color inks to be ejected from the special color head unit 70 are the two color inks Lm and Lc in the aforementioned embodiment, other color inks may be employed and a larger number of color inks may be employed. For example, six color inks Y, M, C, K, Lm, Lc may be employed as normal color inks, and color inks such as orange, g white, metallic, pearlized color inks or clear ink containing no pigment may be employed as special color inks.

According to the present invention, the printing and cutting process may be conducted by feeding the medium M by a medium feeding mechanism such as feeding rollers. Alternatively, the printing and cutting process may be conducted by moving the respective head units while the medium M is fixedly put on a flat bed.

### INDUSTRIAL APPLICABILITY

The present invention is applicable to a printer-plotter apparatus for conducting a printing process on a medium by ejecting ink droplets onto the medium and for conducting a cutting process relative to the medium.
1 . . . printer-plotter apparatus, 10 . . . main body, 30 . . . platen, 40 . . . guide rail, 50 . . . normal color head unit, 51 . . . carriage, 52 . . . inkjet had module, 53 . . . camera, 55 . . . ink tank, 56 . . . tube, 60 . . . cutter unit, 61 . . . carriage, 62 . . . cutter holder, 63 . . . camera, 64 . . . cutter member, 70 . . . special color head unit, 71 . . . carriage, 72 . . . inkjet head module, 73 . . . camera, 75 . . . ink cartridge, 80 . . . first driving carriage, 81 . . . first driving unit, 82 . . . driving pulley, 83 . . . driven pulley, 84 . . . electric motor, 85 . . . driving belt, 86 . . . normal color head unit connecting mechanism, 87 . . . cutter unit connecting mechanism, 90 . . . second driving carriage, 91 . . . second driving unit, 92 . . . driving pulley, 93 . . . driven pulley, 94 . . . electric motor, 95 . . . driving belt, 96 . . . cutter unit connecting mechanism, 97 . . . special color head unit connecting mechanism, 110 . . . right hook mechanism, 120 . . . left hook mechanism, 130, 140 . . . maintenance device, 131, 141 . . . stage, 132, 142 . . . drying prevention member, M . . . medium.

1.-2. (canceled)

3. A printer, comprising:
a guide rail;
a first head unit, a second head unit, and a third head unit each being movably coupled to the guide rail;
a first drive which is disposed between the first head unit and the second head unit and is detachably connected to at least one of the first head unit and the second head unit and which moves along the guide rail; and
a second drive which is disposed between the second head unit and the third head unit and is detachably connected to at least one of the second head unit and the third head unit and which moves along the guide rail.

4. The printer of claim 3, wherein
the first head unit is capable of ejecting normal color ink droplets onto a medium;
the second head unit is capable of conducting a cutting process relative to the medium; and
the third head unit is capable of ejecting special color ink droplets onto the medium.

5. A printer, comprising:
a first head unit, a second head unit, and a third head unit;
a first drive which is disposed between the first head unit and the second head unit and is detachably connected to at least one of the first head unit and the second head unit, wherein the first drive is capable of moving at least one of the first head unit and the second head unit in a first and second direction; and
a second drive which is disposed between the second head unit and the third head unit and is detachably connected to at least one of the second head unit and the third head unit, wherein the second drive is capable of moving at least one of the second head unit and the third head unit in the first and second direction.

6. The printer of claim 5, wherein
the first head is capable of ejecting normal color ink droplets onto a medium;
the second head is capable of conducting a cutting process relative to the medium; and
the third head is capable of ejecting special color ink droplets onto the medium.

7. The printer of claim 5, wherein
the first head unit is capable of printing a first plurality of colors; and
the third head unit is capable of printing a second plurality of colors.

8. The printer of claim 7, wherein the colors printed by the first head unit are used substantially more frequently than the colors printed by the third head unit.

9. The printer of claim 7, wherein at least one of the colors printed by the first head unit and the colors printed by the third head are selected to increase the speed of printing on a medium.

10. The printer of claim 7, wherein the second head unit is a cutter.
